(19) United States
(12) Patent Application Publication
(10) Pub. No.: US 2026/0135128 A1
(43) Pub. Date: May 14, 2026

(54) VOLTAGE MEASUREMENT DEVICE FOR FUEL CELL AND FUEL CELL MODULE

(71) Applicant: INDUSTRIAL TECHNOLOGY RESEARCH INSTITUTE, Hsinchu (TW)

(72) Inventors: Hong-Bao CHANG, Hsinchu City (TW); Yuh-Fwu CHOU, Zhubei City (TW); Chih-Wei HSU, Zhudong Township (TW); Yin-Wen TSAI, Zhubei City (TW); Ku-Yen KANG, Zhubei City (TW); Ching-Jung LIU, Zhudong Township (TW)

(73) Assignee: INDUSTRIAL TECHNOLOGY RESEARCH INSTITUTE, Hsinchu (TW)

(21) Appl. No.: 19/052,745

(22) Filed: Feb. 13, 2025

(30) Foreign Application Priority Data
Nov. 14, 2024 (TW) 113143848

(51) Int. Cl. H01M 8/04537; H01M 8/0202

(52) U.S. Cl. CPC H01M 8/04559; H01M 8/0269

(57) ABSTRACT

A voltage measurement device for a fuel cell and a fuel cell module are provided. The voltage measurement device includes a circuit board including a substrate and electrical contacts on the substrate, a conductive silicone rubber including insulating parts and conductive parts arranged alternately, and a mask disposed between the circuit board and the conductive silicone rubber. The mask includes mask openings separated from each other. The mask openings expose a portion of the conductive parts. The circuit board is electrically connected to the fuel cell through the electrical contacts and the portion of the conductive parts to obtain a voltage value of the fuel cell.

This application claims the benefit of Taiwan application Serial No. 113143848, filed Nov. 14, 2024, the disclosure of which is incorporated by reference herein in its entirety.

### TECHNICAL FIELD

The disclosure relates to a voltage measurement device for a fuel cell and a fuel cell module.

### BACKGROUND

A conventional voltage measurement device for a fuel cell includes a metal ring or probe, and the voltage value of the fuel cell is obtained by connecting the metal ring or probe to the fuel cell. However, when the fuel cell is used in a dynamic environment (such as driving a vehicle), the common impact or vibration in the dynamic environment may change the position of the metal ring or probe and cause problems such as bad connection and/or short circuit, which results in a challenge of voltage measurement. In addition, when a fuel cell includes multiple single cells, errors caused by manufacturing processes and differences in material sizes can make it difficult to align metal rings or probes with the single cells, which also results in a challenge of voltage measurement.

Therefore, there is a need for voltage measurement device which adapts to dynamic environments and has high error tolerance.

### SUMMARY

The disclosure is directed to a voltage measurement device for a fuel cell and a fuel cell module, which uses a mask and a conductive silicone rubber to improve the error tolerance and can adapt to dynamic environments such as driving a vehicle.

According to an embodiment, a voltage measurement device for a fuel cell is provided. The voltage measurement device includes a circuit board, a conductive silicone rubber and a mask. The circuit board includes a substrate and electrical contacts on the substrate. The conductive silicone rubber includes insulating parts and conductive parts arranged alternately. The mask is disposed between the circuit board and the conductive silicone rubber. The mask includes mask openings separated from each other. The mask openings expose a portion of the conductive parts. The circuit board is electrically connected to the fuel cell through the electrical contacts and the portion of the conductive parts to obtain a voltage value of the fuel cell.

According to an embodiment, a voltage measurement device for a fuel cell is provided. The voltage measurement device includes a circuit board, a mask and a conductive silicone rubber. The circuit board includes a substrate and electrical contacts on the substrate. The mask includes mask openings separated from each other. The conductive silicone rubber is disposed between the circuit board and the mask. The conductive silicone rubber includes insulating parts and conductive parts arranged alternately. The mask openings expose a portion of the conductive parts. The circuit board is electrically connected to the fuel cell through the electrical contacts and the portion of the conductive parts to obtain a voltage value of the fuel cell.

According to an embodiment, a fuel cell module is provided. The fuel cell module includes a fuel cell and a voltage measurement device. The fuel cell includes a cell stack. The voltage measurement device is disposed on the cell stack of the fuel cell. The voltage measurement device includes a circuit board, a mask and a conductive silicone rubber. The circuit board includes a substrate and electrical contacts on the substrate. The mask includes mask openings separated from each other. The conductive silicone rubber includes insulating parts and conductive parts arranged alternately. The mask openings expose a portion of the conductive parts. The circuit board is electrically connected to the fuel cell through the electrical contacts and the portion of the conductive parts to obtain a voltage value of the fuel cell.

### BRIEF DESCRIPTION OF THE DRAWINGS

FIG. 1 shows a schematic view of a voltage measurement device and a fuel cell according to an embodiment.

FIG. 2 shows a schematic view of a mask according to an embodiment.

FIG. 3A shows a schematic view of a voltage measurement device and a fuel cell of a comparative example.

FIG. 3B shows a schematic view of a voltage measurement device and a fuel cell according to an embodiment.

FIG. 4A shows a schematic view of a voltage measurement device and a fuel cell of a comparative example.

FIG. 4B shows a schematic view of a voltage measurement device and a fuel cell according to an embodiment.

FIG. 5A shows a schematic view of a voltage measurement device according to an embodiment.

FIG. 5B shows a schematic exploded view of the voltage measurement device according to an embodiment.

FIG. 5C shows a schematic view of a voltage measurement device and a fuel cell according to an embodiment.

FIG. 6 shows a schematic view of a voltage measurement device and a fuel cell according to an embodiment.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

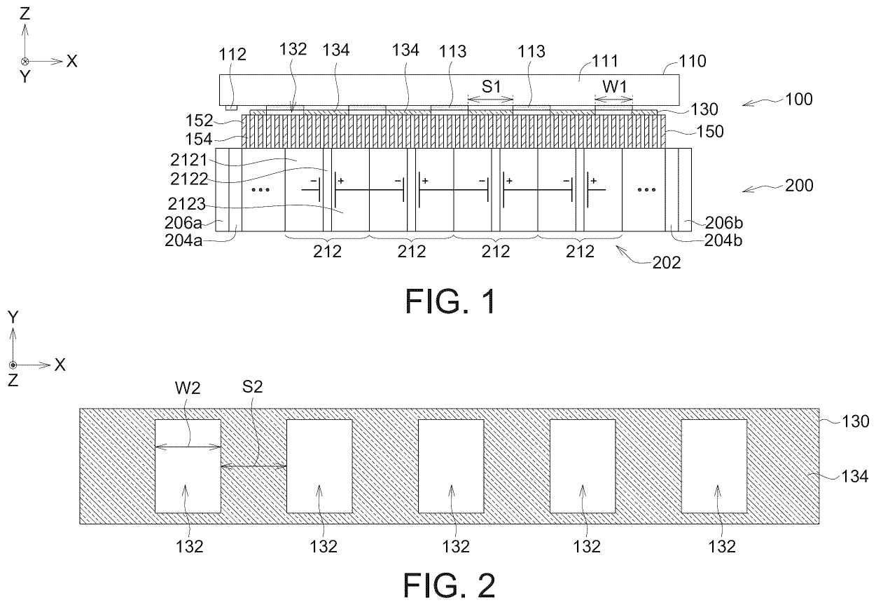

Referring to FIGS. 1 and 2, FIG. 1 shows a schematic view of a voltage measurement device 100 and a fuel cell 200 according to an embodiment, and FIG. 2 shows a schematic view of a mask 130 according to an embodiment. The voltage measurement device 100 and the fuel cell 200 can form a fuel cell module. The voltage measurement device 100 can be used in the fuel cell 200 to measure the voltage of the fuel cell 200. The fuel cell 200 can include a cell stack 202, current collectors 204a and 204b on opposite sides of the cell stack 202, and end plates 206a and 206b on opposite sides of the cell stack 202. The cell stack 202 may include single cells 212. The single cells 221 may be connected in series. Each single cell may include an anode plate 2121, a membrane electrode assembly (MEA) 2122 and a cathode plate 2123. In an embodiment, the anode plate 2121 can include an anode flow field plate. In an embodiment, the cathode plate 2123 can include a cathode flow field plate. In an embodiment, the membrane electrode assembly 2122 can include a catalyst coated membrane (CCM) and a gas diffusion layer (GDL). The current collector 204a may be disposed between the cell stack 202 and the end plate 206a. The current collector 204b may be disposed between the cell stack 202 and the end plate 206b. The anode flow field plate may include an anode flow channel for fuel (such as hydrogen) delivery. The cathode flow field plate may include a cathode flow channel for oxidizing agent (such as oxygen or air) delivery. When the fuel cell 200 is in operation, the hydrogen molecules at the anode can be separated into hydrogen ions and electrons, the electrons move to the current collector 204b and the cathode flow field plate through the anode flow field plate and the current collector 204a, the hydrogen ions move to the cathode through the membrane electrode assembly 2122, and the electrons arriving at the cathode, the hydrogen ions passing through the membrane electrode assembly 2122 and oxygen can form water.

The voltage measurement device 100 can be used to measure the voltage value of the fuel cell 200. The voltage measurement device 100 can be disposed on the cell stack 202 of the fuel cell 200. The voltage measurement device 100 includes a circuit board 110, a mask 130 and a conductive silicone rubber 150. The mask 130 is disposed on the circuit board 110. The conductive silicone rubber 150 is disposed on the circuit board 110. The circuit board 110 can include a substrate 111 and electrical contacts 113 on the substrate 111. The mask 130 includes a sheet or film of an insulating material. The mask 130 can include mask openings 132 separated from each other. The conductive silicone rubber 150 includes conductive parts 152 and insulating parts 154 arranged alternately. The conductive parts 152 are electrically isolated from each other by the insulating parts 154. The mask 130 is disposed on the conductive silicone rubber 150. The mask openings 132 of the mask 130 expose a portion (such as a first portion) of the conductive parts 152 of the conductive silicone rubber 150, and shield another portion (such as a second portion) of the conductive parts 152 of the conductive silicone rubber 150; the first portion is different from the second portion. The circuit board 110 can be electrically connected to the fuel cell 200 through the electrical contacts 113 and the portion (i.e. the first portion) of the conductive parts 152 exposed by the mask openings 132 to obtain a voltage value of the fuel cell 200.

The electrical contacts 113 may be disposed along the X direction and separated from each other on the substrate 111. The circuit board 110 may further include conductive traces (not shown) electrically connected to the electrical contacts 113 and one or more electronic components 112. The conductive traces can be used to transmit voltage signals from the fuel cell 200 to the electronic components 112 of the circuit board 110. The electronic components 112 may be various electronic components such as a computing component. In the present embodiment, the mask 130 is disposed between the circuit board 110 and the conductive silicone rubber 150. The mask 130 may contact the circuit board 110 and the conductive silicone rubber 150. The mask 130 may include a mask body 134 and mask openings 132 penetrating the mask body 134. The mask openings 132 can be arranged along the X direction. FIG. 2 shows that the mask body 134 and the mask opening 132 are rectangular, but the present disclosure is not limited thereto. The mask body 134 and the mask opening 132 can be in any shape.

The conductive parts 152 and the insulating parts 154 of the conductive silicone rubber 150 can be arranged alternately along the X direction. The conductive silicone rubber 150 can be an elastomeric conductive silicone rubber. The conductive silicone rubber 150 may be compressible and flexible. The conductive silicone rubber 150 can be compressed to absorb the thickness of the mask 130 (for example, the thickness in the Z direction), so that the electrical contacts 113 can pass through the mask openings 132 of the mask 130 and be electrically connect to the portion (i.e. the first portion) of the conductive parts 152 exposed by the mask openings 132. The electrical contacts 113 can contact the portion (i.e. the first portion) of the conductive parts 152 exposed by the mask openings 132. As such, the circuit board 110 can be electrically connected to the fuel cell 200 through the electrical contacts 113 and the portion (i.e. the first portion) of the conductive parts 152 exposed by the mask openings 132 to obtain the voltage value of the fuel cell 200. The X direction, the Y direction and the Z direction can be perpendicular to each other.

The circuit board 110 may be a printed circuit board or a flexible circuit board. The electrical contact 113 can be a conductive contact or a gold-plated copper foil interconnection (commonly known as a gold finger). The mask 130 can be made of an insulating polymer material. The mask 130 can be an insulating coating, an insulating tape or other insulating plate. The mask 130 can be an insulating coating applied to the electrical contacts 113. The mask 130 can be an insulating tape attached to the electrical contacts 113. In an embodiment, the mask 130 is formed by spraying the insulating coating (such as polyimide resin) on some regions of the circuit board 130 by an inkjet printing process to form a desired mask pattern, which can achieve effects of pre-alignment and pre-attachment. In another embodiment, before using the inkjet printing process to spray the insulating coating, digital images are used to analyze the width of each voltage collection point on the contact surface between the cell stack of the fuel cell and the conductive silicone rubber 150 to determine the spraying position and width of the aforementioned insulating coating required around each electrical contact 113, which can prevent unnecessary electrical contact without impeding effective voltage collection.

The conductive part 152 of the conductive silicone rubber 150 can be made of conductive silicone rubber. The insulating part 154 of the conductive silicone rubber 150 can be made of insulating silicone rubber. The conductive silicone rubber 150 can be a zebra-type conductive silicone rubber. The conductive silicone rubber 150 can be compressed to form a stable electrical connection between the circuit board 110, the mask 130 and the fuel cell 200. The use of conductive silicone rubber 150 can prevent or improve bad connection and/or short circuit caused by impact or vibration, and thus the voltage measurement device 100 can be can adapt to dynamic environments.

Each electrical contact 113 of the circuit board 110 has a width W1 in the X direction (can also be understood as a first width). Each mask opening 132 of the mask 130 has a width W2 in the X direction (can also be understood as a second width). The width W1 of the electrical contact 113 can be equal to or substantially equal to the width W2 of the mask opening 132, but the present disclosure is not limited thereto. In an embodiment, the width W1 of the electrical contact 113 and the width W2 of the mask opening 132 may respectively be half of the width of the single cell 212 in the X direction. In an embodiment, the width W1 of the electrical contact 113 and the width W2 of the mask opening 132 may respectively be the thickness of the anode plate 2121 in the X direction or the thickness of the cathode plate 2123 in the X direction; or alternatively, the width W1 of the electrical contact 113 and the width W2 of the mask opening 132 may respectively be the average of the thickness of the anode plate 2121 in the X direction and the thickness of the cathode plate 2123 in the X direction.

The electrical contacts 113 of the circuit board 110 can be equidistantly disposed on the substrate 111. There is an interval S1 between two adjacent electrical contacts 113 in the X direction. The mask openings 132 of the mask 130 can be equidistantly disposed on the mask body 134. There is an interval S2 between two adjacent mask openings 132 in the X direction. The interval S1 can be equal to or substantially equal to the interval S2, but the present disclosure is not limited thereto. In an embodiment, the interval S1 and the interval S2 may respectively be half of the width of the single cell 212 in the X direction. In an embodiment, the interval S1 and the interval S2 may respectively be the thickness of the anode plate 2121 in the X direction or the thickness of the cathode plate 2123 in the X direction; or alternatively, the interval S1 and the interval S2 may respectively be the average of the thickness of the anode plate 2121 in the X direction and the thickness of the cathode plate 2123 in the X direction.

In an embodiment, the width of the cathode plate 2123 in the X direction is 2 millimeters. In an embodiment, the width of the cathode plate 2123 in the X direction is 2 millimeters. In an embodiment, the width of the membrane electrode assembly in the X direction is 250 micrometers.

In an embodiment, the sum of the width of one conductive part 152 of the conductive silicone rubber 150 in the X direction and the width of one insulating part 154 adjacent to this conductive part 152 in the X direction is 0.25 millimeters, and this sum can be understood as the pitch of the conductive silicone rubber 150. In an embodiment, the thickness of the conductive silicone rubber 150 in the Z direction is 7.4 millimeters. In an embodiment, the thickness of the mask 130 in the Z direction is 0.06 millimeters.

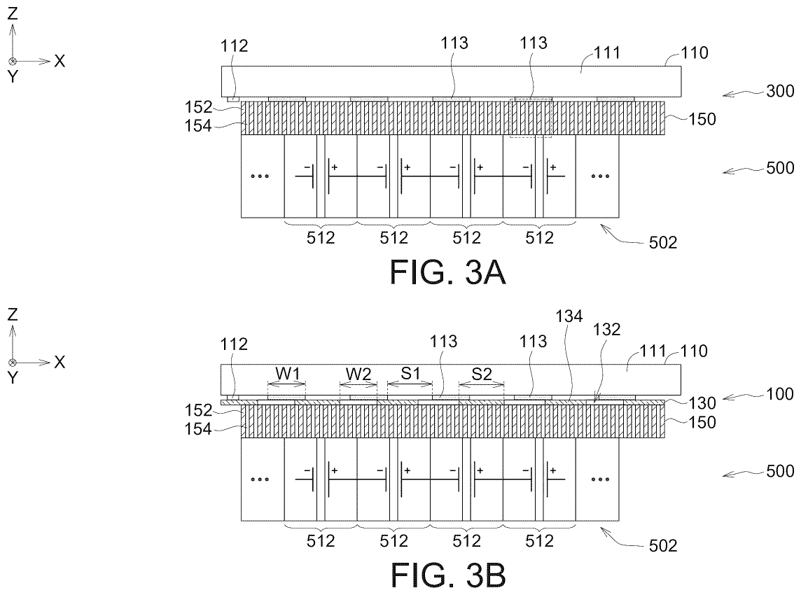

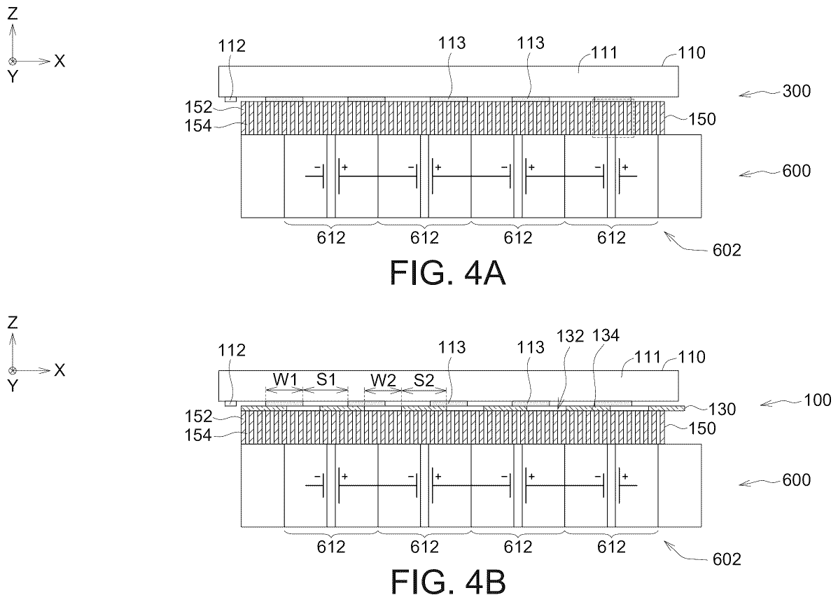

In the voltage measurement device according to the present disclosure, the mask can change the position where the circuit board is electrically connected to the fuel cell to avoid incorrect connections between the voltage measurement device and the fuel cell caused by errors in manufacturing processes and material sizes, and to avoid short circuit caused by incorrect connections between the voltage measurement device and the fuel cell; therefore, the voltage measurement device of the present disclosure has high error tolerance. For example, the position where the circuit board is electrically connected to the fuel cell can be changed by adjusting the position of the mask relative to the fuel cell and/or adjusting the position of the circuit board relative to the fuel cell. In the following description, two of applications of the voltage measurement device of the present disclosure are provided with reference to FIGS. 3A to 4B, but the present is not limited thereto.

FIG. 3A shows a schematic view of a voltage measurement device 300 and a fuel cell 500 of a comparative example. FIG. 3B shows a schematic view of the voltage measurement device 100 and the fuel cell 500 according to an embodiment. The difference between the voltage measurement device 300 of the comparative example and the aforementioned voltage measurement device 100 is that, the voltage measurement device 300 of the comparative example does not include a mask. The difference between the fuel cell 500 and the aforementioned fuel cell 200 is that, the thickness of the anode plate and/or the cathode plate of the single cell 512 of the cell stack 502 of the fuel cell 500 in the X direction is relatively small; that is, as compared with the thickness of the anode plate 2121 and/or the cathode plate 2123 of the single cell 212 of the cell stack 202 of the fuel cell 200 (as a standard), the thickness of the anode plate and/or the cathode plate of the single cell 512 of the cell stack 502 of the fuel cell 500 has a negative error. For clarity, the current collectors and the end plates in the fuel cell 500 are omitted in FIGS. 3A and 3B, and the arrangement of the current collectors and the end plates in the fuel cell 500 can refer to the fuel cell 200 in FIG. 1.

As shown in FIG. 3A, the thickness error of the anode plate and/or cathode plate of the fuel cell 500 causes the measurement points of the anode plate and cathode plate to shift, for example, toward the left side of FIG. 3A; this shift causes the anode plate and cathode plate of the same single cell 512 to be electrically connected to the same electrical contact 113 (as indicated by the dotted line in FIG. 3A), resulting in an incorrect connection between the voltage measurement device 300 and the fuel cell 500, resulting in a short circuit. In this case, the voltage measurement device 300 cannot correctly obtain the voltage value of the fuel cell 500. As shown in FIG. 3B, the positions where the electrical contacts 113 are electrically connected to the anode plate and cathode plate can be adjusted by adjusting the position of the mask 130 of the voltage measurement device 100 of the present disclosure relative to the cell stack 502 of the fuel cell 500, and thus a correct connection between the voltage measurement device 100 and the fuel cell 500 can be ensured, a short circuit can be prevented, and the voltage measurement device 100 can correctly obtain the voltage value of the fuel cell 500.

For example, in FIG. 3B, if the width W1 of the electrical contact 113 is 2 millimeters, the interval S1 between two adjacent electrical contacts 113 is 2 millimeters, the width W2 of the mask opening 132 is 2 millimeters, and the interval S2 between two adjacent mask openings 132 is 2 millimeters, the width of the electrical contact 113 that is not covered by the mask 130 (available electrical contact 113) will be 1 millimeters, and the interval between two adjacent available electrical contacts will be 3 millimeters. In an embodiment, the average thickness of the anode plate of the fuel cell is 1.9 millimeters, the average thickness of the cathode plate is 1.9 millimeters, and the average thickness of the membrane electrode assembly is 0.2 millimeters. The average pitch of the fuel cell in the X direction is 1.9+1.9+0.2=4.0 millimeters. In the present embodiment, the ideal pitch obtained by adding the interval S1 and the width W1 of the circuit board should be the same as that of the fuel cell, which is 4.0 millimeters; the pitch obtained by adding the interval S2 and the width W2 of the mask should also be 4.0 millimeters. As explained previously with reference to FIG. 3B, when the average thickness of a certain batch of fuel cells is relatively small (for example, the pitch is only 3.8 millimeters), a correct connection between the voltage measurement device 100 and the fuel cell 500 can be ensured, a short circuit can be prevented, and the voltage measurement device 100 can reliably obtain the voltage value of the fuel cell 500 by adjusting the position of the mask relative to the fuel cell. In another embodiment where the pitches of the circuit board and the fuel cell are 4.0 millimeters and 3.8 millimeters respectively, a mask with a pitch of 3.6 millimeters is used to adjust the exposed portion of the electrical contacts 113 of the circuit board that contacts the conductive silicone rubber 150 so that a correct connection between the voltage measurement device 100 and the fuel cell 500 is ensured, a short circuit is prevented, and the voltage measurement device 100 can reliably obtain the voltage value of the fuel cell 500. In other embodiments where the pitch of the fuel cell is between 3.6 to 4.0 millimeters, a mask with a pitch of 3.6 millimeters can be used to achieve a similar adjustment and ensure a correct connection between the voltage measurement device and the fuel cell.

FIG. 4A shows a schematic view of the voltage measurement device 300 and a fuel cell 600 of a comparative example. FIG. 4B shows a schematic view of the voltage measurement device 100 and the fuel cell 600 according to an embodiment. The difference between the fuel cell 600 and the aforementioned fuel cell 200 is that, the thickness of the anode plate and/or the cathode plate of the single cell 612 of the cell stack 602 of the fuel cell 600 in the X direction is relatively large; that is, as compared with the thickness of the anode plate 2121 and/or the cathode plate 2123 of the single cell 212 of the cell stack 202 of the fuel cell 200 (as a standard), the thickness of the anode plate and/or the cathode plate of the single cell 612 of the cell stack 602 of the fuel cell 600 has a positive error. For clarity, the current collectors and the end plates in the fuel cell 600 are omitted in FIGS. 4A and 4B, and the arrangement of the current collectors and the end plates in the fuel cell 600 can refer to the fuel cell 200 in FIG. 1.

As shown in FIG. 4A, the thickness error of the anode plate and/or cathode plate of the fuel cell 600 causes the measurement points of the anode plate and cathode plate to shift, for example, toward the right side of FIG. 4A; this shift causes the anode plate and cathode plate of the same single cell 612 to be electrically connected to the same electrical contact 113 (as indicated by the dotted line in FIG. 4A), resulting in an incorrect connection between the voltage measurement device 300 and the fuel cell 600, resulting in a short circuit. In this case, the voltage measurement device 300 cannot correctly obtain the voltage value of the fuel cell 600. As shown in FIG. 4B, the positions where the electrical contacts 113 are electrically connected to the anode plate and cathode plate can be adjusted by adjusting the position of the mask 130 of the voltage measurement device 100 of the present disclosure relative to the cell stack 602 of the fuel cell 600, and thus a correct connection between the voltage measurement device 100 and the fuel cell 600 can be ensured, a short circuit can be prevented, and the voltage measurement device 100 can correctly obtain the voltage value of the fuel cell 600.

For example, in FIG. 4B, if the width W1 of the electrical contact 113 is 2 millimeters, the interval S1 between two adjacent electrical contacts 113 is 2 millimeters, the width W2 of the mask opening 132 is 2 millimeters, and the interval S2 between two adjacent mask openings 132 is 2 millimeters, the width of the electrical contact 113 that is not covered by the mask 130 (available electrical contact 113) will be 1 millimeters, and the interval between two adjacent available electrical contacts will be 3 millimeters. In the present embodiment, the ideal pitch obtained by adding the interval S1 and the width W1 of the circuit board should be the same as that of the fuel cell, which is 4.0 millimeters; the pitch obtained by adding the interval S2 and the width W2 of the mask should also be 4.0 millimeters. As explained previously with reference to FIG. 4B, when the average thickness of a certain batch of fuel cells is relatively large (for example, the pitch is 4.2 millimeters), a correct connection between the voltage measurement device 100 and the fuel cell 600 can be ensured, a short circuit can be prevented, and the voltage measurement device 100 can reliably obtain the voltage value of the fuel cell 600 by adjusting the position of the mask relative to the fuel cell. In another embodiment where the pitches of the circuit board and the fuel cell are 4.0 millimeters and 4.2 millimeters respectively, a mask with a pitch of 4.4 millimeters is used to adjust the exposed portion of the electrical contacts 113 of the circuit board that contacts the conductive silicone rubber 150 so that a correct connection between the voltage measurement device 100 and the fuel cell 600 is ensured, a short circuit is prevented, and the voltage measurement device 100 can reliably obtain the voltage value of the fuel cell 600. In other embodiments where the pitch of the fuel cell is between 4.0 to 4.4 millimeters, a mask with a pitch of 4.4 millimeters can be used to achieve a similar adjustment and ensure a correct connection between the voltage measurement device and the fuel cell.

When the exposed portion of the electrical contacts that contacts the conductive silicone rubber 150 has a width of more than 1 millimeters, the reliability of voltage measurement can be ensured. The distance between the electrical contact and the polar junction of the cell stack is preferably more than 0.2 millimeters to prevent short circuit.

The position of the mask 130 of the present disclosure relative to the cell stack of the fuel cell can be adjusted according to the actual situation, for example, it can be adjusted according to the error of the cell stack; the arrangement of the mask is not limited to the arrangement shown in FIGS. 1, 3B and 4B.

In an embodiment, one voltage measurement device 100 can be used to obtain the voltage value of one fuel cell, for example, obtain the voltage value of each single cell in the fuel cell. In another embodiment, a plurality of voltage measurement devices 100 can be used to obtain the voltage value of one fuel cell; for example, the cell stack of the fuel cell can be divided into N cell groups, each cell group includes at least one single cell, N voltage measurement devices 100 are disposed above the fuel cells, and each voltage measurement device 100 is electrically connected to the single cell(s) in one cell group to obtain the voltage value of each cell group. In the embodiment where a plurality of voltage measurement devices 100 is used, each voltage measurement device 100 can be adjusted according to the error of the cell group to be measured, for example, the position of the mask 130 can be adjusted, which is easy to use and has high adaptability.

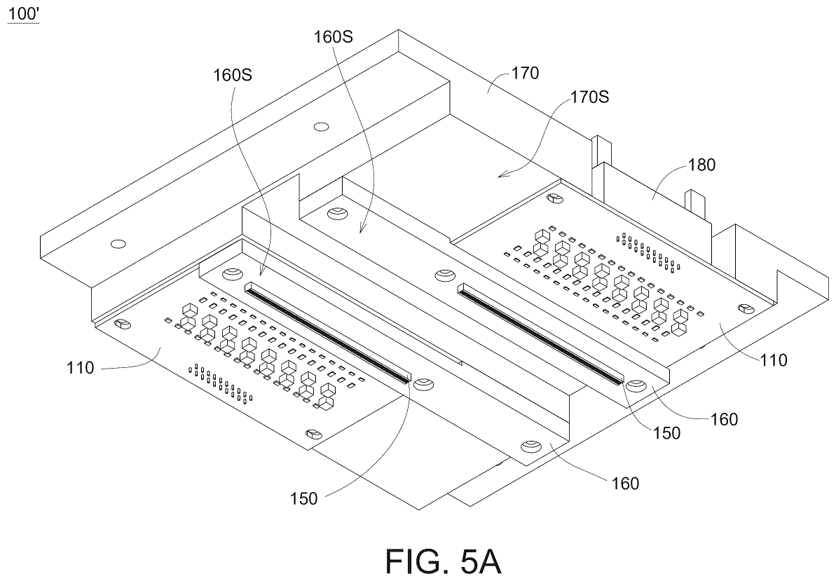

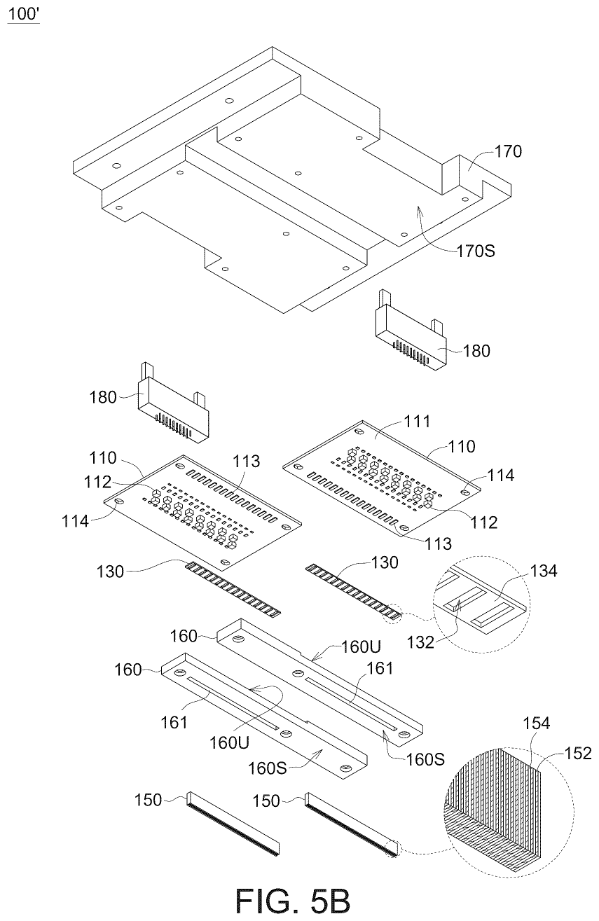

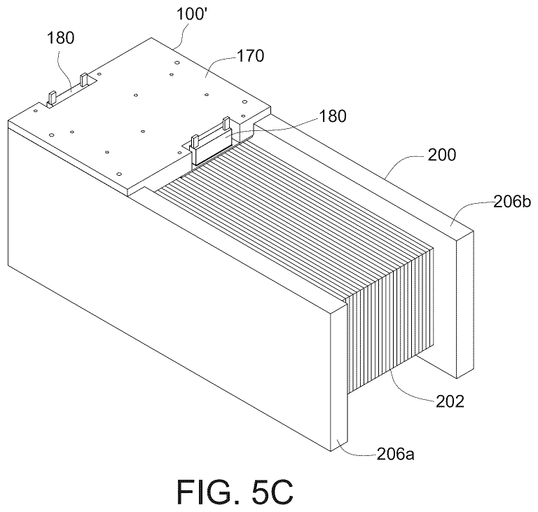

Referring to FIGS. 5A, 5B and 5C, FIG. 5A shows a schematic view of a voltage measurement device 100′ according to an embodiment, FIG. 5B shows a schematic exploded view of the voltage measurement device 100′ of FIG. 5A, and FIG. 5C shows a schematic view of the voltage measurement device 100′ of FIG. 5A and the fuel cell 200 according to an embodiment. The voltage measurement device 100′ and the fuel cell 200 can form a fuel cell module. The difference between the voltage measurement device 100′ and the aforementioned voltage measurement device 100 is that, the voltage measurement device 100′ further includes two holding elements 160, a housing 170 and two signal transmission units 180. In the present disclosure, the number of each component to be installed and disposed in not limited, and the component in the following description will use the singular number. The circuit board 110 can be fixed (such as fastened) on a lower surface 170S of the housing 170 (the drawings show two circuit board 110 fixed in a symmetrical manner). When the voltage measurement device 100′ is disposed on the fuel cell 200 to measure the voltage value of the fuel cell 200, the lower surface 170S of the housing 170 faces the fuel cell 200. The holding element 160 can be disposed on the circuit board 110. The holding element 160 can be fixed (such as fastened) on the lower surface 170S of the housing 170 and the circuit board 110 is between the holding element 160 and the housing 170. The holding element 160 can include an accommodation hole 161 extending from an upper surface 160U of the holding element 160 to a lower surface 160S of the holding element 160. The upper surface 160U of the holding element 160 faces the lower surface 170S of the housing 170. The upper surface 160U of the holding element 160 is opposite to the lower surface 160S of the holding element 160. The mask 130 can be disposed on the upper surface 160U of the holding element 160. The mask 130 is disposed between the holding element 160 and the circuit board 110. The conductive silicone rubber 150 can be disposed in the accommodation hole 161. The shape and size of the accommodation hole 161 can match the shape and size of the conductive silicone rubber 150 so that the conductive silicone rubber 150 can be fixed in the accommodation hole 161. The holding element 160 can cover the electrical contacts of the circuit board 110 so that the electrical contacts, the mask 130 and the conductive silicone rubber 150 can form an electrical connection. The housing 170 can be fixed (such as fastened) on the end plates 206a and 206b. In the present embodiment, the circuit board 110 can include a fastening hole 114 penetrating the substrate 111, the fastening hole 114 may be oval-shaped to flexibly adjust the position of the circuit board 110, so that the position of the mask relative to the fuel cell and/or the position of the circuit board relative to the fuel cell can be adjusted. The signal transmission unit 180 can be disposed on the circuit board 110. The signal transmission unit 180, such as a standard connector, and the holding element 160 can be disposed on opposite sides of the circuit board 110. The signal transmission unit 180 can be electrically connected to or coupled to the circuit board 110. The signal transmission unit 180 may be electrically connected to or coupled to a data processing unit, the voltage value obtained by the circuit board 110 can be transmitted to the data processing unit through the signal transmission unit 180 to monitor the voltage of the fuel cell 200 and/or prevent failure.

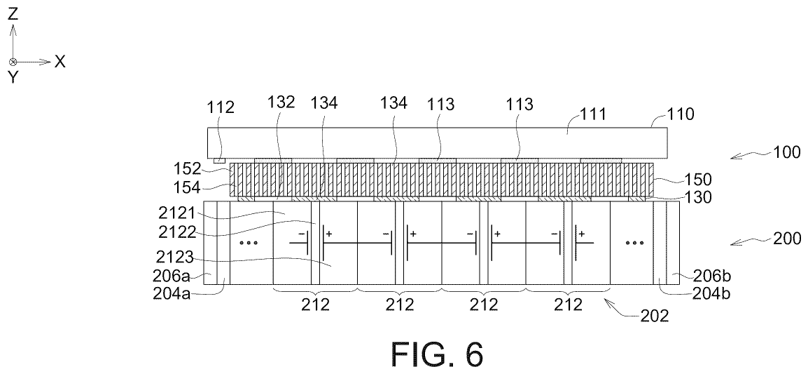

In an embodiment, the conductive silicone rubber 150 of the voltage measurement device 100/100′ can be disposed between the circuit board 110 and the mask 130, that is, the mask 130 can be disposed between the conductive silicone rubber 150 and the fuel cell 200, as shown in FIG. 6. In the present embodiment, the mask 130 can be an insulating coating or insulating tape. The mask 130 may be an insulating coating applied to the conductive silicone rubber 150 or an insulating tape attached to the conductive silicone rubber 150. In an embodiment, the mask 130 can be formed by spraying the insulating coating (such as polyimide resin) on some regions of the conductive silicone rubber 150 by an inkjet printing process to form a desired mask pattern, which can achieve effects of pre-alignment and pre-attachment. In another embodiment, before using the inkjet printing process to spray the insulating coating, digital images are used to analyze the width of each voltage collection point on the contact surface between the cell stack of the fuel cell and the conductive silicone rubber 150 to determine the spraying position and width of the aforementioned insulating coating required around the conductive parts 152 of the conductive silicone rubber 150, which can prevent unnecessary electrical contact without impeding effective voltage collection.

In an embodiment, the conductive silicone rubber 150 of the voltage measurement device 100/100′ can be disposed between the circuit board 110 and the mask 130, that is, the mask 130 can be disposed between the conductive silicone rubber 150 and the fuel cell 200, as shown in FIG. 6. In the present embodiment, the mask 130 can be formed by spraying the insulating coating (such as polyimide resin) on some regions of the cell stack 202 of the fuel cell 200 by an inkjet printing process to form a desired mask pattern, which can achieve effects of pre-alignment and pre-attachment. In another embodiment, before using the inkjet printing process to spray the insulating coating, digital images are used to analyze the width of each voltage collection point on the contact surface between the cell stack 202 and the conductive silicone rubber 150 to determine the spraying position and width of the aforementioned insulating coating required for each cell stack 202, which can prevent unnecessary electrical contact without impeding effective voltage collection.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A voltage measurement device for a fuel cell, comprising:
a circuit board comprising a substrate and electrical contacts on the substrate;
a conductive silicone rubber comprising insulating parts and conductive parts arranged alternately; and
a mask disposed between the circuit board and the conductive silicone rubber, and comprising mask openings separated from each other,
wherein the mask openings expose a portion of the conductive parts, the circuit board is electrically connected to the fuel cell through the electrical contacts and the portion of the conductive parts to obtain a voltage value of the fuel cell.

2. The voltage measurement device according to claim 1, wherein the mask openings of the mask are arranged along a direction, and the insulating parts and the conductive parts of the conductive silicone rubber are arranged alternately along the direction.

3. The voltage measurement device according to claim 1, wherein the mask is made of an insulating polymer material.

4. The voltage measurement device according to claim 1, wherein each of the electrical contacts has a first pitch, each of the mask openings of the mask has a second pitch, and the first pitch is equal to or substantially equal to the second pitch.

5. The voltage measurement device according to claim 1, wherein each of the electrical contacts has a first width, each of the mask openings of the mask has a second width, and the first width is equal to or substantially equal to the second width.

6. The voltage measurement device according to claim 5, wherein the mask openings of the mask are arranged along a direction, the insulating parts and the conductive parts of the conductive silicone rubber are arranged alternately along the direction, and the first width and the second width are in the direction.

7. The voltage measurement device according to claim 1, further comprising:
a holding element comprising an accommodation hole, the conductive silicone rubber is disposed in the accommodation hole;
a signal transmission unit electrically connected to the circuit board, the signal transmission unit and the holding element are disposed on opposite sides of the circuit board; and
a housing, the circuit board is fixed on a lower surface of the housing, and the circuit board is between the holding element and the housing.

8. The voltage measurement device according to claim 1, wherein the mask is an insulating coating applied to the electrical contacts of the circuit board.

9. The voltage measurement device according to claim 8, wherein the insulating coating is sprayed on the circuit board by an inkjet printing process.

10. The voltage measurement device according to claim 1, wherein the mask is an insulating tape attached to the electrical contacts of the circuit board.

11. A voltage measurement device for a fuel cell, comprising:
a circuit board comprising a substrate and electrical contacts on the substrate;
a mask comprising mask openings separated from each other; and
a conductive silicone rubber disposed between the circuit board and the mask, the conductive silicone rubber comprises insulating parts and conductive parts arranged alternately,
wherein the mask openings expose a portion of the conductive parts, the circuit board is electrically connected to the fuel cell through the electrical contacts and the portion of the conductive parts to obtain a voltage value of the fuel cell.

12. The voltage measurement device according to claim 11, wherein each of the electrical contacts has a first pitch, each of the mask openings of the mask has a second pitch, and the first pitch is equal to or substantially equal to the second pitch.

13. The voltage measurement device according to claim 11, wherein each of the electrical contacts has a first width, each of the mask openings of the mask has a second width, and the first width is equal to or substantially equal to the second width.

14. The voltage measurement device according to claim 13, wherein the mask openings of the mask are arranged along a direction, the insulating parts and the conductive parts of the conductive silicone rubber are arranged alternately along the direction, and the first width and the second width are in the direction.

15. The voltage measurement device according to claim 11, further comprising:
a holding element comprising an accommodation hole, the conductive silicone rubber is disposed in the accommodation hole;
a signal transmission unit electrically connected to the circuit board, the signal transmission unit and the holding element are disposed on opposite sides of the circuit board; and
a housing, the circuit board is fixed on a lower surface of the housing, and the circuit board is between the holding element and the housing.

16. The voltage measurement device according to claim 11, wherein the mask is an insulating coating applied to the conductive silicone rubber.

17. The voltage measurement device according to claim 16, wherein the insulating coating is sprayed on the conductive silicone rubber by an inkjet printing process.

18. The voltage measurement device according to claim 11, wherein the mask is an insulating tape attached to the conductive silicone rubber.

19. A fuel cell module, comprising:
a fuel cell comprising a cell stack; and
a voltage measurement device disposed on the cell stack of the fuel cell and comprising:
a circuit board comprising a substrate and electrical contacts on the substrate;
a mask comprising mask openings separated from each other; and
a conductive silicone rubber comprising insulating parts and conductive parts arranged alternately,
wherein the mask openings expose a portion of the conductive parts, the circuit board is electrically connected to the fuel cell through the electrical contacts and the portion of the conductive parts to obtain a voltage value of the fuel cell.

20. The fuel cell module according to claim 19, wherein the mask is an insulating coating applied to the cell stack.

21. The fuel cell module according to claim 19, wherein the mask is an insulating coating applied to the circuit board.

22. The fuel cell module according to claim 19, wherein the mask is an insulating coating applied to the conductive silicone rubber.

23. The fuel cell module according to claim 19, wherein the mask is disposed between the circuit board and the conductive silicone rubber.

24. The fuel cell module according to claim 19, wherein the conductive silicone rubber is disposed between the circuit board and the mask.
